(19) United States
(12) Patent Application Publication
(10) Pub. No.: US 2024/0105185 A1
(43) Pub. Date: Mar. 28, 2024

(54) AGENT SYSTEM

(71) Applicant: SUBARU CORPORATION, Tokyo (JP)

(72) Inventors: Tsukasa MIKUNI, Tokyo (JP); Takuya HOMMA, Tokyo (JP); Junichi MOTOYAMA, Tokyo (JP); Ryota NAKAMURA, Tokyo (JP); Kazuhiro HAYAKAWA, Tokyo (JP)

(21) Appl. No.: 18/460,838

(22) Filed: Sep. 5, 2023

(30) Foreign Application Priority Data
Sep. 27, 2022 (JP) 2022-154272

(51) Int. Cl. G10L 17/22; G10L 17/02

(52) U.S. Cl. CPC G10L 17/22; G10L 17/02

(57) ABSTRACT

An agent system includes a microphone, a speaker, an interpretation unit, a memory, and a control processor. The microphone collects voices of occupants in the interior of a vehicle compartment of a vehicle. The speaker outputs a voice sound to the interior of the vehicle compartment. The interpretation unit acquires the voices of the occupants collected by the microphone and interprets contents of utterances of the occupants included in the voices acquired. The memory stores data on the utterances interpreted by the interpretation unit and data on the respective occupants who are utterers of the utterances associated with each other. The control processor designates an occupant who has uttered most frequently among the occupants as a listener based on the data stored in the memory, determines topics to be outputted to the listener, and performs control to output the topics as the voice sound via the speaker.

### CROSS-REFERENCE TO RELATED APPLICATIONS

The present application claims priority from Japanese Patent Application No. 2022-154272 filed on Sep. 27, 2022, the entire contents of which are hereby incorporated by reference.

### BACKGROUND

The disclosure relates to an agent system.

In recent years, an agent system with a concierge function to conduct a dialogue with an occupant of a vehicle has been known.

An example of the systems is disclosed in, for example, Japanese Unexamined Patent Application Publication (JP-A) No. 2020-60861. When an occupant of the vehicle talks to the system disclosed in JP-A No. 2020-60861, the system identifies which occupant is talking to the system, and responds to the occupant.

### SUMMARY

An aspect of the disclosure provides an agent system to be applied to a vehicle. The agent system includes a microphone, a speaker, an interpretation unit, a memory, and a control processor. The microphone is configured to collect voices of occupants in an interior of a vehicle compartment of the vehicle. The speaker is configured to output a voice sound to the interior of the vehicle compartment. The interpretation unit is configured to acquire the voices of the occupants collected by the microphone and interpret contents of utterances of the occupants included in the voices acquired. The memory is configured to store data on the utterances interpreted by the interpretation unit and data on the respective occupants who are utterers of the utterances associated with each other. The control processor is configured to designate an occupant who has uttered most frequently among the occupants as a listener based on the data stored in the memory, determine topics to be outputted to the listener, and perform control to output the topics as the voice sound via the speaker.

An aspect of the disclosure provides an agent system to be applied to a vehicle. The agent system includes a microphone, a speaker, circuitry, and a memory. The microphone is configured to collect voices of occupants in an interior of a vehicle compartment of the vehicle. The speaker is configured to output a voice sound to the interior of the vehicle compartment. The circuitry is configured to acquire the voices of the occupants collected by the microphone and interpret contents of utterances of the occupants included in the voices acquired. The memory is configured to store data on the utterances interpreted by the circuitry and data on the respective occupants who are utterers of the utterances associated with each other. The circuitry is further configured to designate an occupant who has uttered most frequently among the occupants as a listener based on the data stored in the memory, determine topics to be outputted to the listener, and perform control to output the topics as the voice sound via the speaker.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram illustrating an exemplary configuration of an agent system according to one example embodiment of the disclosure.

FIG. 2 is a diagram illustrating an exemplary process of storing voice data in a memory according to one example embodiment of the disclosure.

FIG. 3 is a diagram illustrating the contents of posts on social media collected by an information acquisition unit according to one example embodiment of the disclosure.

FIG. 4 is a diagram illustrating an example of website browsing history information collected by the information acquisition unit according to one example embodiment of the disclosure.

FIG. 5 is a flowchart of a process to be performed by the agent system according to one example embodiment of the disclosure.

FIG. 6 is a diagram illustrating an exemplary configuration of an agent system according to one example embodiment of the disclosure.

FIG. 7 is a diagram illustrating an example of search word history information collected by an information acquisition unit according to one example embodiment of the disclosure.

FIG. 8 is a table illustrating another example of the search word history information collected by the information acquisition unit according to one example embodiment of the disclosure.

FIG. 9 is a flowchart of a process to be performed by the agent system according to one example embodiment of the disclosure.

### DETAILED DESCRIPTION

A system disclosed in JP-A No. 2020-60861 responds to an occupant in a vehicle when the occupant talks to the system. However, the system disclosed in JP-A No. 2020-60861 still has room for improvement in terms of actively conducting a dialogue with the occupant.

It is desirable to provide an agent system that makes it possible to actively determine a topic of a dialogue, identify a listener, and conduct the dialogue with the listener.

### First Example Embodiment

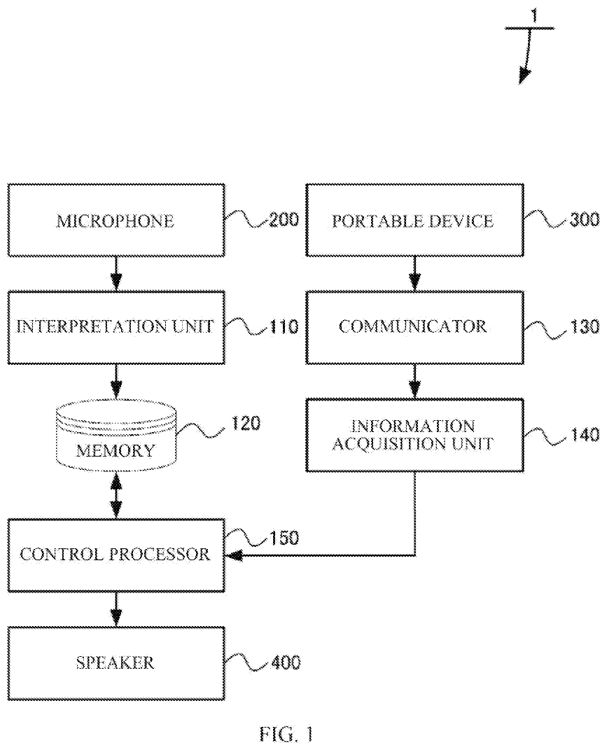

In the following, an agent system 1 according to a first example embodiment is described with reference to FIGS. 1 to 5. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### <Configuration of Agent System 1>

As illustrated in FIG. 1, the agent system 1 according to the first example embodiment may include an interpretation unit 110, a memory 120, a communicator 130, an information acquisition unit 140, a control processor 150, a microphone 200, a portable device 300, and a speaker 400.

In the following, a description is given of an example in which the agent system 1 has a concierge function.

The interpretation unit 110 acquires voices of occupants collected by the microphone 200 to be described later, and interprets the contents of utterances included in the voices acquired.

For example, the interpretation unit 110 may interpret the contents of the utterances and vocal sounds of utterers using an artificial intelligent (AI) function.

In one example, the interpretation unit 110 may store trained models obtained by learning a large amount of human voice data. The interpretation unit 110 may interpret the contents of the utterances and the vocal sound of the utterers using these trained models.

Note that the contents of the utterances and the vocal sounds of the utterers interpreted by the interpretation unit 110 may be stored in association with each other in the form of a database in the memory 120 to be described later.

The memory 120 may store the contents of the utterances and the vocal sounds of the utterers interpreted by the interpretation unit 110 in association with each other.

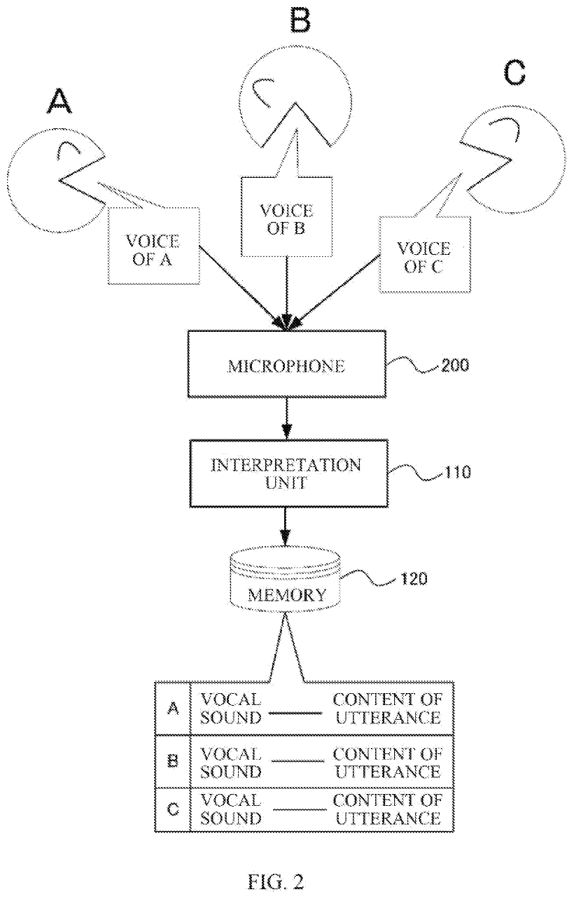

For example, as illustrated in FIG. 2, utterers A, B, and C may be tentatively determined based on vocal sounds, and the contents of utterances of the utterers A, B, and C may be classified according to the utterers A, B, and C when being stored in the memory 120.

The communicator 130 may be, for example, a communication module that communicates with the portable device 300 to be described later.

The communicator 130 may communicate with the portable device 300 via Bluetooth (registered trademark), Wi-Fi, or a cellular communication network, for example.

The communicator 130 may start communicating with the portable device 300 held by the occupant, which is to be described later, via a near field communication such as Wi-Fi or Bluetooth when the vehicle is powered on, for example.

Herein, the portable device 300 may be a smartphone or a tablet owned by the occupant, for example.

The information acquisition unit 140 may acquire information on the occupant from the portable device 300 via the communicator 130.

The information on the occupant may include, for example, the content of a post on social media or website browsing history information.

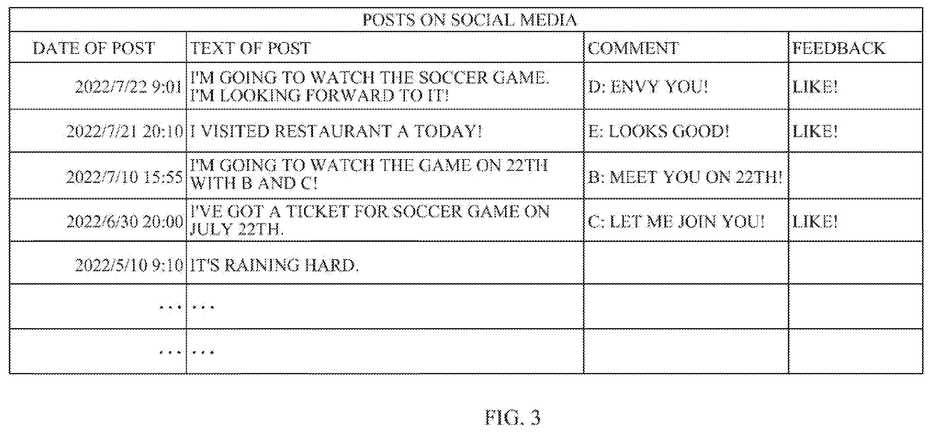

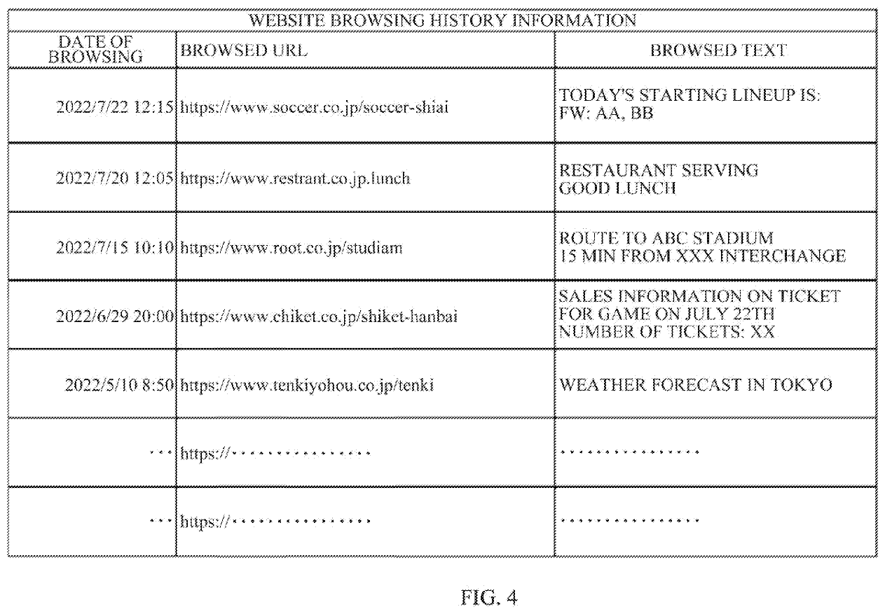

As illustrated in FIG. 3, the content of a post on social media may include the date of the post, and text data indicating the content of the post, for example. The text data indicating the content of the post may include a comment or feedback to the post from another user. As illustrated in FIG. 4, the website browsing history information may include the date of browsing, the URL of a website browsed, and text data of the website, for example.

The information on the occupant acquired by the information acquisition unit 140 may be outputted to the control processor 150 to be described later.

Before acquiring the information on the occupant from the portable device 300 to be described later, the information acquisition unit 140 may cause a message asking the occupant whether he/she permits retrieving of the information on the occupant to be displayed on a display of the portable device 300 to be described later. After confirming the permission of the occupant, the information acquisition unit 140 may start retrieving the information on the occupant. Alternatively, the information acquisition unit 140 may cause options of information on the occupant to be retrieved to be displayed on the display of the portable device 300 to be described later. The occupant may select an option of the information retrievable, and the information acquisition unit 140 may start retrieving only the information selected by the occupant.

The control processor 150 may control an overall operation of the agent system 1 in accordance with a control program stored in a non-illustrated read only memory (ROM).

In the first example embodiment, the control processor 150 may search the information on the occupant acquired by the information acquisition unit 140 for a latest event, and determine a topic of a dialogue based on the latest event.

Further, the control processor 150 may designate an occupant who has uttered most frequently as a listener based on the information stored in the memory 120, and may perform control to output the topic to the listener via the speaker 400, for example.

In one example, the control processor 150 may designate one of the utterers A, B, and C whose data is the largest in volume as the listener based on the voice data classified according to the utterers A, B, and C and stored in the memory 120 as illustrated in FIG. 2. Further, the control processor 150 may identify the latest post or the latest website browsing history information based on the contents and dates of posts on social media or the dates of browsing in the web site browsing history information acquired from the portable device 300 of the occupant to be described later. The control processor 150 may then identify the latest event of the occupant from the content of the latest post and the latest website browsing history information using an AI system based on a trained model, determine the latest event to be a topic of a dialogue, and output the topic to the speaker 400 to be described later.

For example, as illustrated in FIG. 3, the control processor 150 may identify the latest post, e.g., “I'm going to watch a soccer game. I'm looking forward to it!” from the occupant's posts on social media. Further, as illustrated in FIG. 4, the control processor 150 may identify the latest event of the occupant, e.g., “watching the soccer game”, from the latest website browsing history information, e.g., “starting lineup of the soccer game”. The control processor 150 may determine a matter relating to “soccer” to be the topics, and may output the matters relating to “soccer” via the speaker 400.

In one example, the speaker 400 may output a voice sound such as “How was the today's soccer game?” or “Did you enjoy watching the soccer game?”

The microphone 200 collects voices of the occupants in an interior of the vehicle compartment of the vehicle.

For example, multiple microphones 200 may be disposed at respective locations in the interior of the vehicle compartment so that voices of the occupants are appropriately collected.

The voice data on the voices of the occupants collected by the microphone 200 may be outputted to the interpretation unit 110.

The speaker 400 outputs a voice sound relating to the topic to the interior of the vehicle compartment.

For example, multiple speakers 400 may be disposed at respective locations in the interior of the vehicle compartment so that the occupants are able to recognize the topic outputted to the interior of the vehicle compartment.

### <Process in Agent System 1>

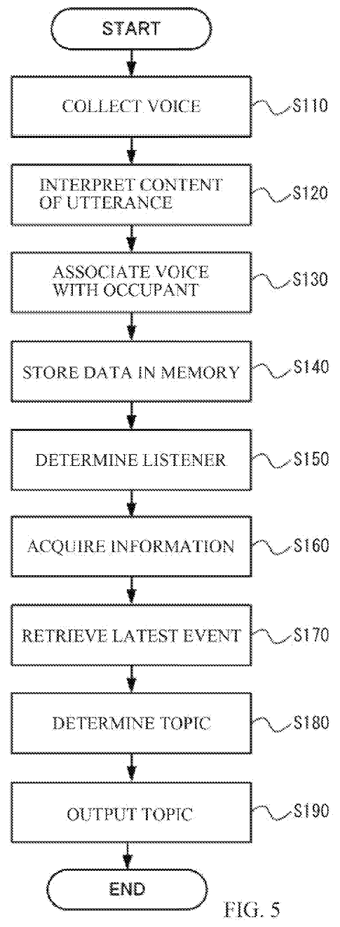

An exemplary process to be performed by the agent system 1 according to the first example embodiment is described with reference to FIG. 5.

First, the microphone 200 may collect voice data on, for example, conversations made by the occupants in the interior of the vehicle compartment (Step S110).

Thereafter, the voice data collected by the microphone 200 may be outputted to the interpretation unit 110. The interpretation unit 110 may interpret the contents of utterances of the occupants included in the voice data acquired from the microphone 200 (Step S120).

The control processor 150 may associate the interpreted contents of the utterances with respective vocal sounds of the occupants who are utterers of the utterances (Step S130), and may store the contents of the utterances interpreted by the interpretation unit 110 in the memory 120 after classifying the contents of the utterances according to the utterers, i.e., the vocal sounds of the utterers A, B, and C (Step S140).

The control processor 150 may designate the occupant who has uttered most frequently as the listener based on the vocal sounds classified according to the occupants and stored in the memory 120, for example (Step S150).

The communicator 130 may communicate with the portable device 300 of the occupant, and output information received from the portable terminal 300 to the information acquisition unit 140. The information acquisition unit 140 may acquire the information on the occupant from the information received from the communicator 130 (Step S160).

The control processor 150 may retrieve the latest event of the occupant designated as the listener from the information on the occupant acquired by the information acquisition unit 140 (Step S170), and may determine a topic based on the latest event retrieved (Step S180).

The control processor 150 may output the determined topic as voice data to the listener in the interior of the vehicle compartment via the speaker 400 (Step S190).

### <Workings and Effects>

According to the agent system 1 of the first example embodiment described above, the interpretation unit 110 acquires voices of the occupants collected by the microphone 200 and interprets the contents of utterances of the occupants included in the voices acquired. The control processor 150 designates the occupant who has uttered most frequently as the listener based on the data on the voices interpreted by the interpretation unit 110 and the data on the occupants who are the utterers that are associated with each other and stored in the memory 120, determines the topic to be outputted to the listener, and outputs the topic as a voice sound to the listener via the speaker 400.

That is, the control processor 150 may extract the occupant who has uttered most frequently from the data on the voices interpreted by the interpretation unit 110 and the data on the respective utterers that are associated with each other and stored in the memory 120, and may designate the extracted occupant as the listener. Based on the contents of the utterances associated with the respective utterers, the control processor 150 may determine a frequently used theme to be the topic that the listener is supposed to be interested in, and may present the topic to the interior of the vehicle compartment via the speaker 400.

Since the theme that the listener who has uttered most frequently is interested in is determined as the topic to be outputted, a conversation in the interior of the vehicle compartment is led and facilitated by the person who uttered most frequently. This leads to a smooth conversation between the occupants in the interior of the vehicle compartment, creating pleasant space in the vehicle compartment.

Further, the information acquisition unit 140 may acquire the information on the occupants from the portable devices 300 of the occupants, and the control processor 150 may retrieve the latest event from the information on the occupant designated as the listener out of the information on the occupants acquired by the information acquisition unit 140. The control processor 150 may determine the topic based on the latest event, and may output the topic via the speaker 400.

That is, the control processor 150 may retrieve the latest event of the occupant designated as the listener from the information acquired from the portable device 300 of the occupant by the information acquisition unit 140. Thereafter, the control processor 150 may determine the theme relating to the latest event to be the topic, assuming that the latest event is the event that the listener has the greatest interest in. The control processor 150 may present the topic to the occupants in the interior of the vehicle compartment via the speaker 400.

This urges the occupant who has the greatest interest in the topic to begin to talk, which triggers an active conversation between the occupants where the occupant designated as the listener responds to questions from the other occupants or the other occupants make appropriate responses.

This results in an active and smooth conversation between the occupants in the interior of the vehicle compartment. It is therefore possible to create pleasant space in the interior of the vehicle compartment.

### Second Example Embodiment

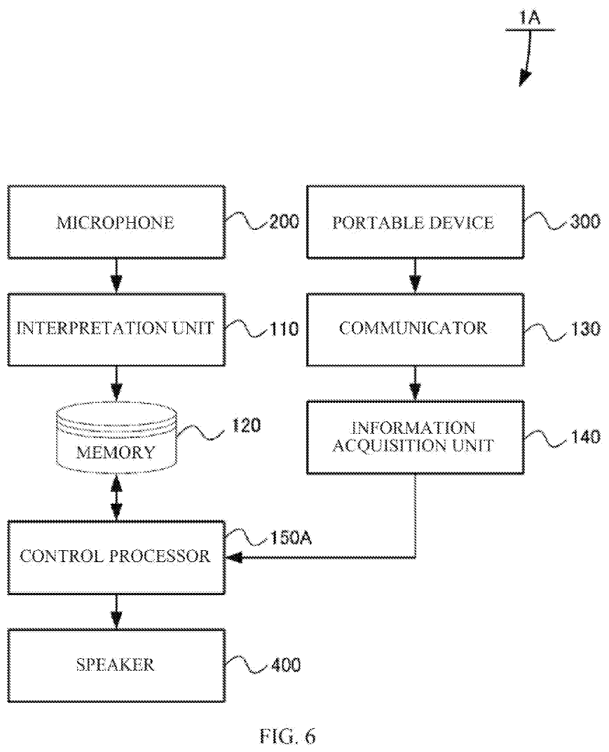

In the following, an agent system 1A according to a second example embodiment is described with reference to FIGS. 6 to 9.

### <Configuration of Agent System 1A>

As illustrated in FIG. 6, the agent system 1A according to the second example embodiment may include the interpretation unit 110, the memory 120, the communicator 130, the information acquisition unit 140, a control processor 150A, the microphone 200, and the speaker 400.

In the following, a description is given of an example in which the agent system 1A has a concierge function.

Note that components denoted by the same reference numerals as those in the first example embodiment have substantially the same functions as those in the first example embodiment, and detailed descriptions thereof are omitted.

The control processor 150A may control an overall operation of the agent system 1A in accordance with a control program stored in a non-illustrated read only memory (ROM), for example.

In the second example embodiment, the control processor 150A may designate an occupant exhibiting a distinctive tendency in a word search as the listener.

In addition, the control processor 150A may determine matters relating to the word that the occupant designated as the listener has used in the word search most frequently to be the topics, and may perform control to output the topics to the listener via the speaker 400, for example.

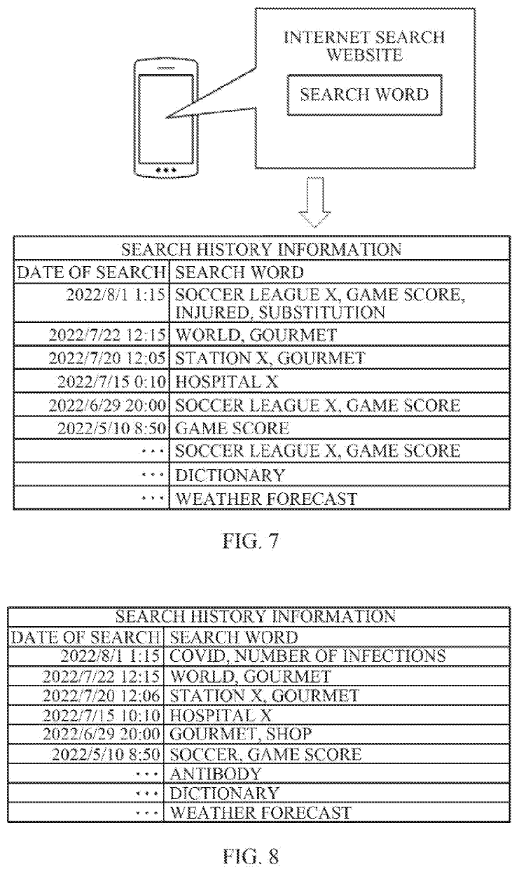

For example, as illustrated in FIG. 7, when acquiring data indicating that an occupant has searched for words including “soccer” frequently from search word history information in the portable devices 300, the control processor 150A may designate this occupant exhibiting the distinctive tendency in the word search as the listener.

Further, when the occupant designated as the listener has searched for matters relating to “soccer league X, game score” most frequently, the control processor 150A may determine “soccer league X” and “game score” to be the topics, and may output the topics via the speaker 400.

For example, voice sounds such as “Which soccer team won the game?” and “The soccer league X is playing today.” may be outputted via the speaker 400.

Further, the control processor 150A may output the topics determined based on the searching tendency of the occupant designated as the listener via the speaker 400 to the listener after excluding a negative topic from the topics.

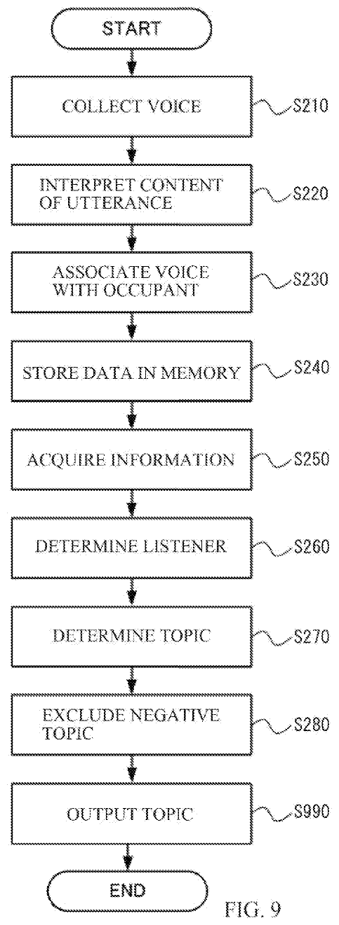

For example, as illustrated in FIG. 8, when contents relating to “gourmet” are extracted as the topics based on the searching tendency, the control processor 150A may determine a topic relating to “out of business” among the contents relating to “gourmet” to be the negative topic using a trained model preliminarily trained, and may exclude the negative topic from the extracted topics relating to “gourmet” before outputting the topics via the speaker 400.

In one example, a topic, “Restaurant X has gone out of business.” may be excluded from the topics to be outputted, and topics such as “Do you have any favorite restaurant around here?” or “Let me know a dish you like recently.” may be outputted via the speaker 400.

### <Process in Agent System 1A>

An exemplary process to be performed by the agent system 1A according to the second example embodiment is described with reference to FIG. 9.

First, the microphone 200 may collect voice data on, for example, conversations made by the occupants in the interior of the vehicle compartment (Step S210).

Thereafter, the voice data collected by the microphone 200 may be outputted to the interpretation unit 110. The interpretation unit 110 may interpret the contents of utterances of the occupants included in the voice data acquired from the microphone 200 (Step S220).

The control processor 150A may associate the interpreted contents of the utterances with respective vocal sounds of the occupant who are utterers of the utterances (Step S230), and may store the contents of the utterances interpreted by the interpretation unit 110 in the memory 120 after classifying the contents of the utterances according to the utterers into the memory 120 (Step S240).

The communicator 130 may communicate with the portable device 300 of the occupant, and the information acquisition unit 140 may acquire the information on the occupant from the portable device 300 of the occupant (Step S250).

The control processor 150A may designate the occupant exhibiting the distinctive tendency in the word search as the listener based on the information on the occupants acquired by the information acquisition unit 140 (Step S260), and may determine matters relating to the word that the listener has used in word search most frequently to be the contents of a topic (Step S270).

The control processor 150A may exclude a negative topic from the contents of the topic determined based on the searching tendency (Step S280), and may output the contents of the topic as voice data to the listener in the interior of the vehicle compartment via the speaker 400 (Step S290).

### <Workings and Effects>

According to the agent system 1A of the second example embodiment described above, the information acquisition unit 140 acquires the information on the occupants from the portable devices 300 of the occupants. The control processor 150A may designate the occupant exhibiting the distinctive tendency in the word search as the listener based on the search word history information, may determine the matters relating to the word that the listener has used in the word search most frequently to be a topic to be outputted, and may perform control to output the topic as voice data via the speaker 400 disposed in the interior of the vehicle compartment.

That is, the control processor 150A may extract the occupant exhibiting the distinctive tendency in the word search from the search word history information of the occupants acquired by the information acquisition unit 140, and may designate the extracted occupant as the listener. The control processor 150A may present the theme relating to the word that the listener has used in the word search most frequently as the topic to the interior of the vehicle compartment via the speaker 400.

Since the theme relating to the word that the listener exhibiting the distinctive tendency in the word search has used in the word search most frequently is outputted as the topic, it is expected that the topic triggers an active conversation between the occupants where the other occupants respond to the theme that the listener is interested in.

This leads to a smooth conversation between the occupants in the interior of the vehicle compartment, creating pleasant space in the vehicle compartment.

Further, when the themes relating to the word that the occupant exhibiting the distinctive tendency in the word search and designated as the listener has used in the word search most frequently are determined to be the topics, the control processor 150A of the agent system 1A according to the second example embodiment may perform control to output the topics as voice data via the speaker 400 disposed in the interior of the vehicle compartment after excluding a negative topic from the topics.

That is, the control processor 150A may extract the occupant exhibiting the distinctive tendency in the word search, may designate the extracted occupant as the listener, and may present the themes relating to the word that the listener has used in the word search most frequently as the topics to the interior of the vehicle compartment via the speaker 400 after excluding a negative topic from the themes.

This urges the occupant having the greatest interest in the topic to begin to talk, which triggers an active conversation between the occupants where the occupant designated as the listener responds to questions from the other occupants or the other occupants make appropriate responses.

This leads to an active and smooth conversation between the occupants in the interior of the vehicle compartment, creating pleasant space in the interior of the vehicle compartment.

Note that it is possible to implement the agent system 1 or 1A of the example embodiments of the disclosure by recording the processes to be executed by, for example, the control processor 150 or 150A on a non-transitory recording medium readable by a computer system, and causing, for example, the control processor 150 or 150A to load the programs recorded on the non-transitory recording medium thereon to execute the programs. The computer system as used herein may encompass an operating system (OS) and hardware such as a peripheral device.

In addition, when the computer system utilizes a World Wide Web (WWW) system, the “computer system” may encompass a website providing environment (or a website displaying environment). The program may be transmitted from a computer system that contains the program in a storage device or the like to another computer system via a transmission medium or by a carrier wave in a transmission medium. The “transmission medium” that transmits the program may refer to a medium having a capability to transmit data, including a network (e.g., a communication network) such as the Internet and a communication link (e.g., a communication line) such as a telephone line.

Further, the program may be directed to implement a part of the operation described above. The program may be a so-called differential file (differential program) configured to implement the operation by a combination of a program already recorded on the computer system.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

According to one or more of the example embodiments of the disclosure, it is possible to provide the agent system that makes it possible to actively determine a topic of a dialogue, identify a listener, and conduct the dialogue with the listener. It is therefore possible to facilitate a smooth conversation between the occupants in the interior of the vehicle compartment and create pleasant space in the vehicle compartment.

The interpretation unit 110 in FIGS. 1 and 3 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the interpretation unit 110. Such a medium may take many forms, including, but not limited to, any type of magnetic medium such as a hard disk, any type of optical medium such as a CD and a DVD, any type of semiconductor memory (i.e., semiconductor circuit) such as a volatile memory and a nonvolatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the interpretation unit 110 in FIGS. 1 and 3.

1. An agent system to be applied to a vehicle, the agent system comprising:
a microphone configured to collect voices of occupants in an interior of a vehicle compartment of the vehicle;
a speaker configured to output a voice sound to the interior of the vehicle compartment;
an interpretation unit configured to acquire the voices of the occupants collected by the microphone and interpret contents of utterances of the occupants included in the voices acquired;
a memory configured to store data on the utterances interpreted by the interpretation unit and data on the respective occupants who are utterers of the utterances associated with each other; and
a control processor configured to designate an occupant who has uttered most frequently among the occupants as a listener based on the data stored in the memory, determine topics to be outputted to the listener, and perform control to output the topics as the voice sound via the speaker.

2. The agent system according to claim 1, further comprising
an information acquisition unit configured to establish communication between portable devices of the occupants and the vehicle to acquire information on the occupants, wherein
the control processor is configured to
retrieve a latest event from information on the occupant designated as the listener out of the information on the occupants acquired by the information acquisition unit, and
determine the topics based on the latest event retrieved.

3. The agent system according to claim 1, further comprising
an information acquisition unit configured to establish communication between portable devices of the occupants and the vehicle to acquire information on the occupants, wherein
the control processor is configured to
designating an occupant exhibiting a distinctive tendency in a word search among the occupants as the listener based on the information on the occupants acquired by the information acquisition unit, and
determine matters relating to a word that the occupant designated as the listener has used in the word search most frequently to be the topics.

4. The agent system according to claim 3, wherein the control processor is configured to exclude a negative topic from the topics determined based on the tendency in the word search of the occupant designated as the listener when determining the topics.

5. An agent system to be applied to a vehicle, the agent system comprising:
a microphone configured to collect voices of occupants in an interior of a vehicle compartment of the vehicle;
a speaker configured to output a voice sound to the interior of the vehicle compartment; and
circuitry configured to acquire the voices of the occupants collected by the microphone and interpret contents of utterances of the occupants included in the voices acquired; and
a memory configured to store data on the utterances interpreted by the circuitry and data on the respective occupants who are utterers of the utterances associated with each other; wherein
the circuitry is further configured to
designate an occupant who has uttered most frequently among the occupants as a listener based on the data stored in the memory,
determine topics to be outputted to the listener, and
perform control to output the topics as the voice sound via the speaker.
